(19) United States
(12) Patent Application Publication
(10) Pub. No.: US 2009/0161774 A1
(43) Pub. Date: Jun. 25, 2009

(54) Apparatus and Method for Dynamic Frequency Selection in ofdm Networks

(76) Inventors: Hang Liu, Yardley, PA (US); Wen Gao, West Windsor, NJ (US)

Correspondence Address: Thomson Licensing LLC, P.O. Box 5312, Two Independence Way, PRINCETON, NJ, 08543-5312, US

(21) Appl. No.: 12/084,515

(22) PCT Filed: Nov. 1, 2006
(86) PCT No.: PCT/US2006/042839

§ 371 Date: May 2, 2008

Related U.S. Application Data
(60) Provisional application No. 60/734,123, filed on Nov. 7, 2005.

(51) Int. Cl. H04L 27/28

(52) U.S. Cl. 375/260

(57) ABSTRACT

A wireless endpoint is a Wireless Regional Area Network (WRAN) endpoint, such as a base station (BS) or customer premise equipment (CPE). The WRAN endpoint can transmit an orthogonal frequency division multiplexed (OFDM) signal comprising 2048 subcarriers in a channel. The 2048 subcarriers are divided into 16 subcarrier sets, or subchannels, each subcarrier set comprising 128 subcarriers. However, upon detection of an incumbent narrowband signal in the channel, the WRAN endpoint forms the OFDM signal for transmission in such a way that the WRAN endpoint excludes use of those one, or more, of the subcarrier sets that would interfere with the incumbent narrowband signal.

### BACKGROUND OF THE INVENTION

The present invention generally relates to communications systems and, more particularly, to wireless systems, e.g., terrestrial broadcast, cellular, Wireless-Fidelity (Wi-Fi), satellite, etc.

A Wireless Regional Area Network (WRAN) system is being studied in the IEEE 802.22 standard group. The WRAN system is intended to make use of unused television (TV) broadcast channels in the TV spectrum, on a non-interfering basis, to address, as a primary objective, rural and remote areas and low population density underserved markets with performance levels similar to those of broadband access technologies serving urban and suburban areas. In addition, the WRAN system may also be able to scale to serve denser population areas where spectrum is available.

### SUMMARY OF THE INVENTION

As noted above, one goal of the WRAN system is not to interfere with existing incumbent signals, such as TV broadcasts, which may be considered a “wideband” signal, i.e., the signal takes up the entire channel. However, there may also be incumbent signals in a channel that are “narrowband” in comparison to a TV broadcast. In this regard, a wireless endpoint uses a dynamic frequency selection mechanism such that the wireless endpoint can still use the channel—yet avoid interfering with the incumbent narrowband signal. In particular, and in accordance with the principles of the invention, a wireless endpoint identifies at least one excluded frequency region within a channel and transmits an orthogonal frequency division multiplexed (OFDM) based signal in the channel, the OFDM based signal including a number of subcarriers; wherein the transmitting step includes the step of excluding from transmission those subcarriers that fall within the at least one excluded frequency region.

In an illustrative embodiment of the invention, a wireless endpoint is a Wireless Regional Area Network (WRAN) endpoint, such as a base station (BS) or customer premise equipment (CPE). The WRAN endpoint can transmit an OFDM signal comprising 2048 subcarriers in a channel. The 2048 subcarriers are divided into 16 subcarrier sets, or subchannels, each subcarrier set comprising 128 subcarriers. However, upon detection of an incumbent narrowband signal in the channel, the WRAN endpoint forms the OFDM signal for transmission in such a way that the WRAN endpoint excludes use of those one, or more, of the subcarrier sets that would interfere with the incumbent narrowband signal.

In another illustrative embodiment of the invention, a wireless endpoint is a Wireless Regional Area Network (WRAN) endpoint, such as a base station (BS) or customer premise equipment (CPE). The WRAN endpoint can transmit an OFDM signal comprising 2048 subcarriers in a channel. The 2048 subcarriers are divided into 16 subcarrier sets, or subchannels, each subcarrier set comprising 128 subcarriers. However, upon receipt of a frequency usage map identifying an incumbent narrowband signal in the channel, the WRAN endpoint forms the OFDM signal for transmission in such a way that the WRAN endpoint excludes use of those one, or more, of the subcarrier sets that would interfere with the incumbent narrowband signal.

In view of the above, and as will be apparent from reading the detailed description, other embodiments and features are also possible and fall within the principles of the invention.

### BRIEF DESCRIPTION OF THE DRAWINGS

FIG. 1 shows Table One, which lists television (TV) channels;

FIG. 2 shows an illustrative WRAN system in accordance with the principles of the invention;

FIGS. 3, 4 and 5 relate to OFDMA transmission in the WRAN system of FIG. 2;

FIG. 6 shows an illustrative flow chart for use in the WRAN system of FIG. 2 in accordance with the principles of the invention;

FIG. 7 shows another illustrative flow chart for use in the WRAN system of FIG. 2 in accordance with the principles of the invention;

FIG. 8 shows an illustrative receiver for use in the WRAN system of FIG. 2 in accordance with the principles of the invention;

FIG. 9 shows another illustrative flow chart for use in the WRAN system of FIG. 4 in accordance with the principles of the invention;

FIG. 10 shows an illustrative message flow in accordance with the principles of the invention;

FIG. 11 shows another illustrative flow chart for use in the WRAN system of FIG. 4 in accordance with the principles of the invention;

FIG. 12 shows an illustrative frequency usage map in accordance with the principles of the invention; and

FIG. 13 shows an illustrative OFDM modulator in accordance with the principles of the invention.

### DETAILED DESCRIPTION

Other than the inventive concept, the elements shown in the figures are well known and will not be described in detail. Also, familiarity with television broadcasting, receivers, networking and video encoding is assumed and is not described in detail herein. For example, other than the inventive concept, familiarity with current and proposed recommendations for TV standards such as ATSC (Advanced Television Systems Committee) (ATSC) and networking such as IEEE 802.16, 802.11h, etc., is assumed. Further information on ATSC broadcast signals can be found in the following ATSC standards: Digital Television Standard (A/53), Revision C, including Amendment No. 1 and Corrigendum No. 1, Doc. A/53C; and Recommended Practice: Guide to the Use of the ATSC Digital Television Standard (A/54). Likewise, other than the inventive concept, transmission concepts such as eight-level vestigial sideband (8-VSB), Quadrature Amplitude Modulation (QAM), orthogonal frequency division multiplexing (OFDM) or orthogonal frequency division multiple access (OFDMA), and receiver components such as a radio-frequency (RF) front-end, or receiver section, such as a low noise block, tuners, and demodulators, correlators, leak integrators and squarers is assumed. Similarly, other than the inventive concept, formatting and encoding methods (such as Moving Picture Expert Group (MPEG)-2 Systems Standard (ISO/IEC 13818-1)) for generating transport bit streams are well-known and not described herein. It should also be noted that the inventive concept may be implemented using conventional programming techniques, which, as such, will not be described herein. Finally, like-numbers on the figures represent similar elements.

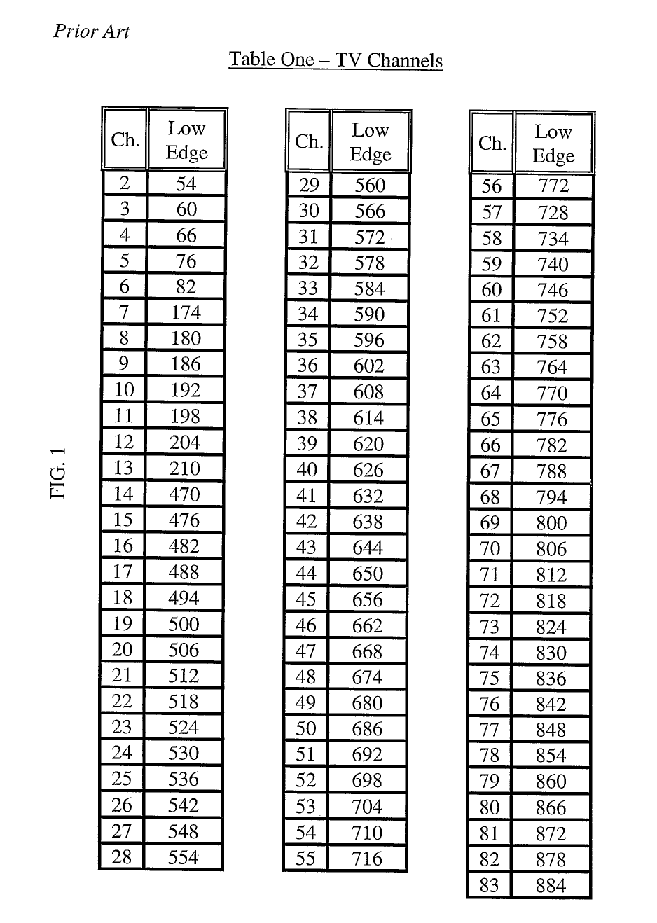

A TV spectrum for the United States is shown in Table One of FIG. 1, which provides a list of TV channels in the very high frequency (Vim) and ultra high frequency (UHF) bands. For each TV channel, the corresponding low edge of the assigned frequency band is shown. For example, TV channel 2 starts at 54 MHz (millions of hertz), TV channel 37 starts at 608 MHz and 30 TV channel 68 starts at 794 MHz, etc. As known in the art, each TV channel, or band, occupies 6 MHz of bandwidth. As such, TV channel 2 covers the frequency spectrum (or range) 54 MHz to 60 MHz, TV channel 37 covers the band from 608 MHz to 614 MHz and TV channel 68 covers the band from 794 MHz to 800 MHz, etc. In the context of this description, a TV broadcast signal is a “wideband” signal. As noted earlier, a WRAN system makes use of unused television (TV) broadcast channels in the TV spectrum. In this regard, the WRAN system performs “channel sensing” to determine which of these TV channels are actually active (or “incumbent”) in the WRAN area in order to determine that portion of the TV spectrum that is actually available for use by the WRAN system.

However, even if a WRAN endpoint does not detect a wideband signal, there may also be incumbent signals in a channel that are “narrowband”, e.g., that occupy less than the 6 MHz of bandwidth in a channel. An incumbent narrowband signal may appear even after the WRAN endpoint has begun to use the channel for transmission. In this regard, a wireless endpoint uses a dynamic frequency selection (DFS) mechanism such that the wireless endpoint can still use the channel—yet avoid interfering with the incumbent narrowband signal. In particular, and in accordance with the principles of the invention, a wireless endpoint identifies at least one excluded frequency region within a channel and transmits an orthogonal frequency division multiplexed (OFDM) based signal in the channel, the OFDM based signal including a number of subcarriers; wherein the transmitting step includes the step of excluding from transmission those subcarriers that fall within the at least one excluded frequency region.

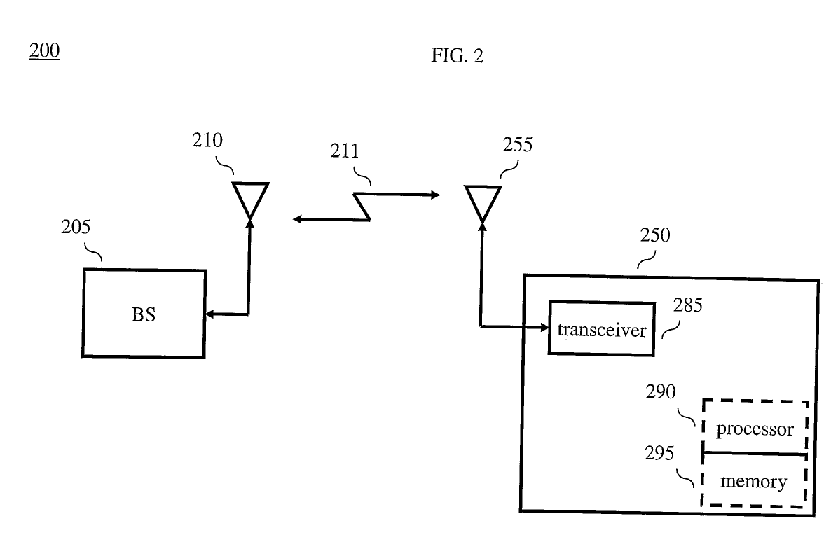

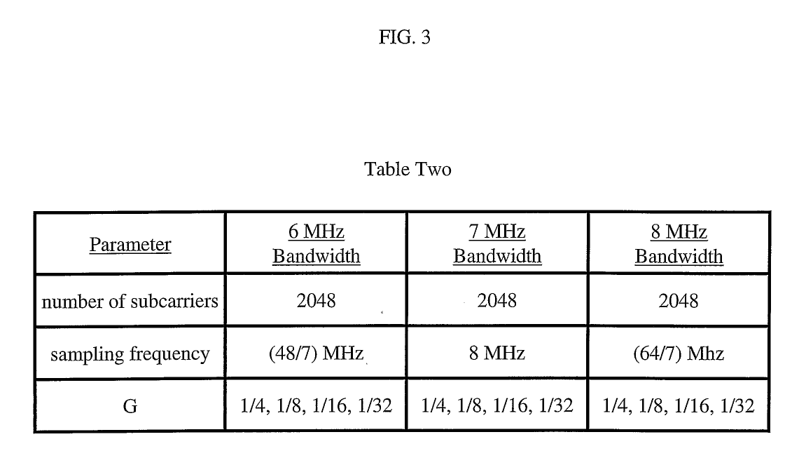

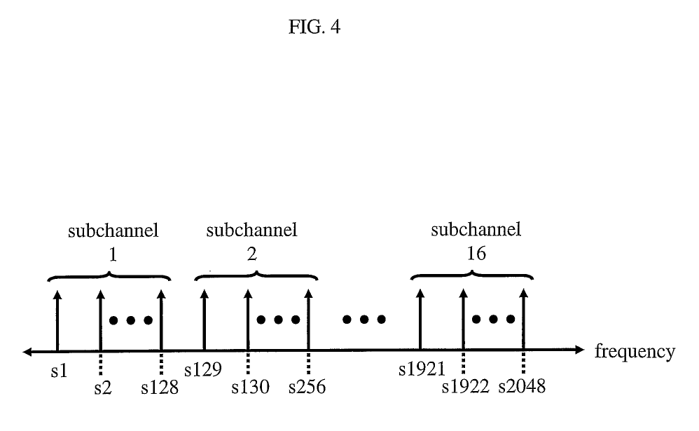

An illustrative Wireless Regional Area Network (WRAN) system 200 incorporating the principles of the invention is shown in FIG. 2. WRAN system 200 serves a geographical area (the WRAN area) (not shown in FIG. 2). In general terms, a WRAN system comprises at least one base station (BS) 205 that communicates with one, or more, customer premise equipment (CPE) 250. The latter may be stationary or mobile. CPE 250 is a processor-based system and includes one, or more, processors and associated memory as represented by processor 290 and memory 295 shown in the form of dashed boxes in FIG. 2. In this context, computer programs, or software, are stored in memory 295 for execution by processor 290. The latter is representative of one, or more, stored-program control processors and these do not have to be dedicated to the transmitter function, e.g., processor 290 may also control other functions of CPE 250. Memory 295 is representative of any storage device, e.g., random-access memory (RAM), read-only memory (ROM), etc.; may be internal and/or external to CPE 250; and is volatile and/or non-volatile as necessary. The physical layer (PHY) of communication between BS 205 and CPE 250, via antennas 210 and 255, is illustratively OFDM-based, e.g., OFDMA, via transceiver 285 and is represented by arrows 211. Illustrative OFDMA signal parameters for bandwidths of 6 MHz, 7 MHz and 8 MHz are show in Table Two of FIG. 3. For example, for a bandwidth of 6 MHz, the number of subcarriers is equal to 2048, the sampling frequency is (48/7) MHz and the values of ¼, ⅛, 1/16 and 1/32 are supported for the parameter G, which is the ratio of cyclic prefix (CP) to “useful” time. In the context of this description, the 2048 subcarriers are further divided into 16 subchannels as illustrated in FIG. 4. For example, subchannel 1 comprises subcarriers s1 through s128, subchannel 2 comprises subcarriers 129 through s256, and so on up to subchannel 16, which comprises subcarriers s1921 through s2048. For simplicity, and as shown in FIG. 4, it is assumed that the subcarriers in each subchannel are adjacent in frequency to each other but the inventive concept is not so limited and a subchannel may be defined such that some, or all, of the subcarriers are not adjacent in frequency.

To enter a WRAN network, CPE 250 first attempts to “associate” with BS 205. During this attempt, CPE 250 transmits information, via transceiver 285, on the capability of CPE 250 to BS 205 via a control channel (not shown). The reported capability includes, e.g., minimum and maximum transmission power, and a supported channel list for transmission and receiving. In this regard, CPE 250 performs the above-mentioned “channel sensing” to determine which TV channels are not active in the WRAN area. The resulting available channel list for use in WRAN communications is then provided to BS 205. The latter uses the above-described reported information to decide whether to allow CPE 250 to associate with BS 205.

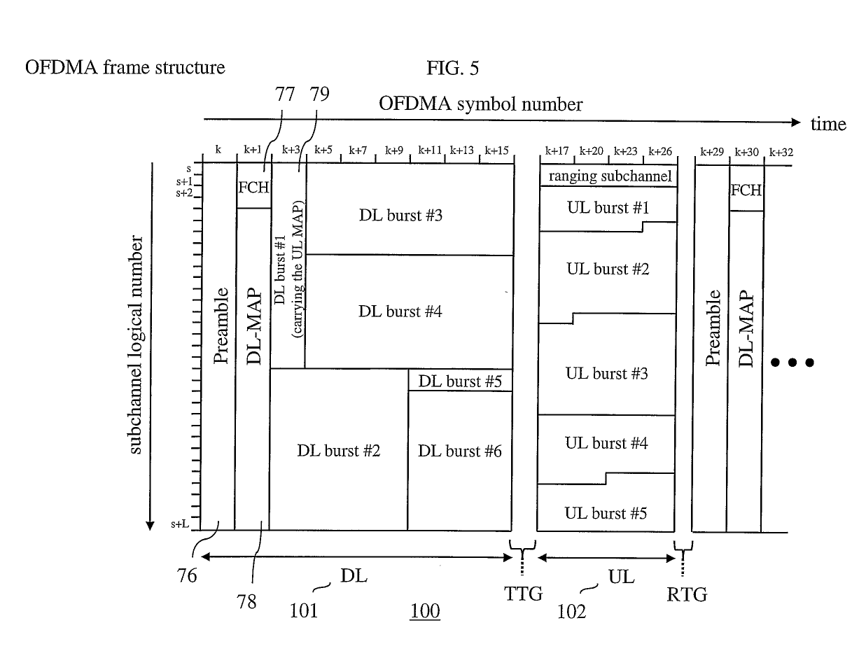

An illustrative frame 100 for use in communicating information between BS 205 and CPE 250 is shown in FIG. 5. Other than the inventive concept, frame 100 is similar to an OFDMA frame as described in IEEE 802.16-2004, “IEEE Standard for Local and metropolitan area networks, Part 16: Air Interface for Fixed Broadband Wireless Access Systems”. Frame 100 is representative of a time division duplex (TDD) system in which the same frequency band is used for uplink (UL) and downlink (DL) transmission. As used herein, uplink refers to communications from CPE 250 to BS 205, while downlink refers to communications from BS 205 to CPE 250. Each frame comprises two subframes, a DL subframe 101 and a UL subframe 102. In each frame, time intervals are included to enable BS 205 to turn around (i.e., switch from transmit to receive and vice versa). These are shown in FIG. 5 as an RTG (receive/transmit transition gap) interval and a TTG (transmit/receive transition gap) interval. Each subframe conveys data in a number of bursts. Information about the frame and the number of DL bursts in the DL subframe and the number of UL bursts in the UL subframe are conveyed in frame control header (FCH) 77, DL MAP 78 and UL MAP 79. Each frame also includes a preamble 76, which provides frame synchronization and equalization.

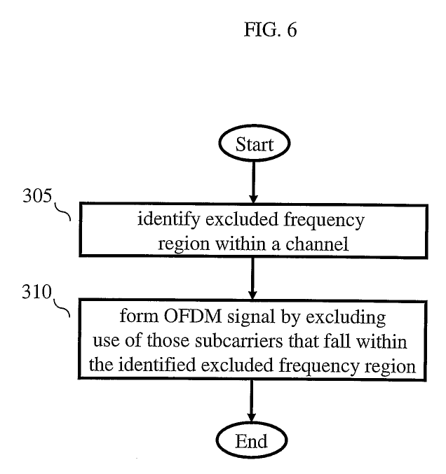

Turning now to FIG. 6, an illustrative flow chart for use in performing DFS in accordance with the principles of the invention is shown. In step 305, CPE 250 identifies one, or more, frequency regions that art to be excluded when forming an OFDM signal. In the following step, 310, CPE 250 forms the OFDM signal by excluding use of those subcarriers that fall within the identified excluded frequency region. Preferably, in order to detect incumbent signals in a channel, CPE 250 should cease transmission in that channel during the detection period. In this regard, BS 205 may schedule a quite interval by sending a control message via DL subframe 101 of frame 100 to CPE 250. The scheduled quiet interval may span multiples frames or just just relate to a UL subframe.

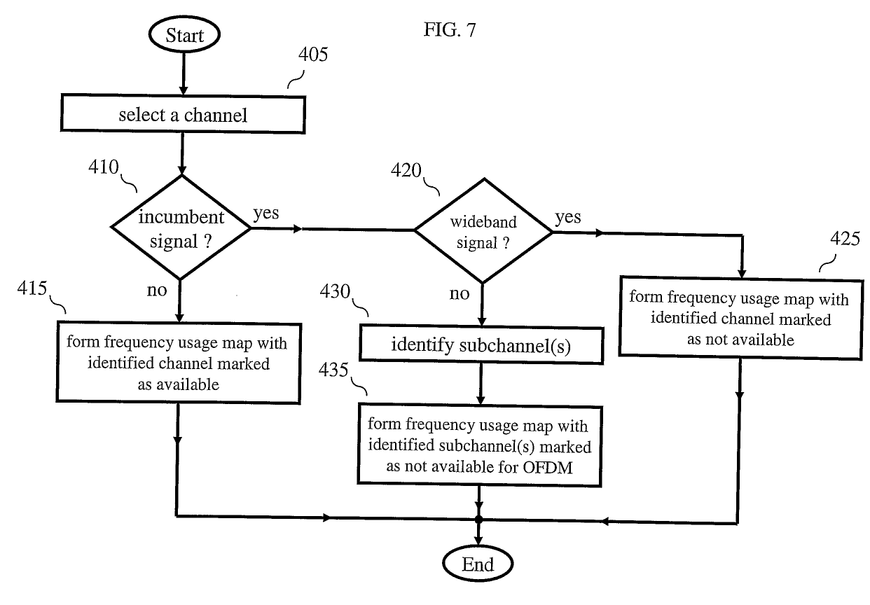

One illustrative way of identifying one, or more, excluded frequency regions as required by step 305 is shown in the flow chart of FIG. 7. In step 405, CPE 250 selects a channel. In this example, the channel is assumed to be one of the TV channels shown in Table One of FIG. 1 but the inventive concept is not so limited and applies to other channels having other bandwidths. In step 410, CPE 250 scans the selected channel to check for the existence of an incumbent signal. If no incumbent signal has been detected, then, in step 415, CPE 250 forms a frequency usage map, which indicates that the identified channel is available for use by the WRAN system. As used herein, a frequency usage map is simply a data structure that identifies one, or more, channels, and parts thereof, as available or not for use in the WRAN system of FIG. 2. However, if an incumbent signal is detected, then, in step 420, CPE 250 determines if the detected incumbent signal is a wideband signal, e.g., if the detected signal occupies substantially all of the channel bandwidth. If the detected incumbent signal is a wideband signal, then, in step 425, CPE 250 forms a frequency usage map, which indicates that the identified channel not available for use by the WRAN system. On the other hand, if the detected incumbent signal is not a wideband signal, i.e., the detected incumbent signal is a narrowband signal, then, in step 430, CPE 250 identifies one, or more, subchannels that is occupied by the detected narrowband signal. In this example, 16 subchannels make up a channel as illustrated in FIG. 4. In step 435, CPE 250 forms a frequency usage map, which indicates those identified subchannels of the 16 that are not available for use by the WRAN system. As such, in step 310 of FIG. 6, CPE 250 forms the OFDM signal such that any identified subchannels (and, therefore, the associated subcarriers) are excluded from use in forming the OFDM signal.

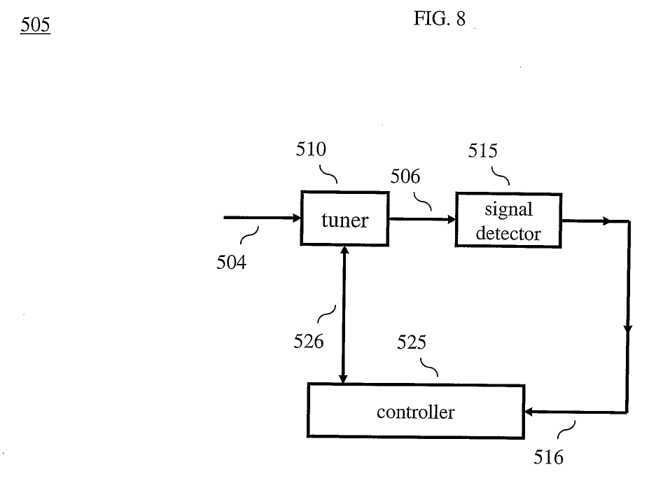

Turning briefly to FIG. 8, an illustrative portion of a receiver 505 for use in CPE 250 is shown (e.g., as a part of transceiver 285). Only that portion of receiver 505 relevant to the inventive concept is shown. Receiver 505 comprises tuner 510, signal detector 515 and controller 525. The latter is representative of one, or more, stored-program control processors, e.g., a microprocessor (such as processor 290), and these do not have to be dedicated to the inventive concept, e.g., controller 525 may also control other functions of receiver 505. In addition, receiver 505 includes memory (such as memory 295), e.g., random-access memory (RAM), read-only memory (ROM), etc.; and may be a part of, or separate from, controller 525. For simplicity, some elements are not shown in FIG. 8, such as an automatic gain control (AGC) element, an analog-to-digital converter (ADC) if the processing is in the digital domain, and additional filtering. Other than the inventive concept, these elements would be readily apparent to one skilled in the art. In this regard, the embodiments described herein may be implemented in the analog or digital domains. Further, those skilled in the art would recognize that some of the processing may involve complex signal paths as necessary.

In the context of the above-described flow charts, tuner 510 is tuned to different ones of the channels by controller 525 via bidirectional signal path 526 to select particular TV channels. For each selected channel, an input signal 504 may be present. Input signal 504 may represent an incumbent wideband signal such as a digital VSB modulated signal in accordance with the above-mentioned “ATSC Digital Television Standard”, or an incumbent narrowband signal. If there is an incumbent signal in the selected channel, tuner 510 provides a downconverted signal 506 to signal detector 515, which processes signal 506 to determine if signal 506 is an incumbent wideband signal or an incumbent narrowband signal. Signal detector 515 provides the resulting information to controller 525 via path 516.

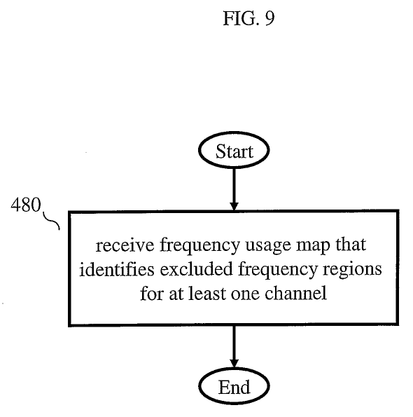

Another illustrative way for a wireless endpoint to identify one, or more, excluded frequency regions as required by step 305 is shown in the flow chart of FIG. 9. In this example, in step 480, CPE 250 receives a frequency usage map from BS 205, which indicates any channels and/or subchannels that are not available for use by the WRAN system. BS 205 forms this frequency usage map by, e.g., performing the above-described flow chart of FIG. 7. As such, in step 310 of FIG. 6, CPE 250 forms the OFDM signal such that any identified subchannels (and, therefore, the associated subcarriers) are excluded from use in forming the OFDM signal.

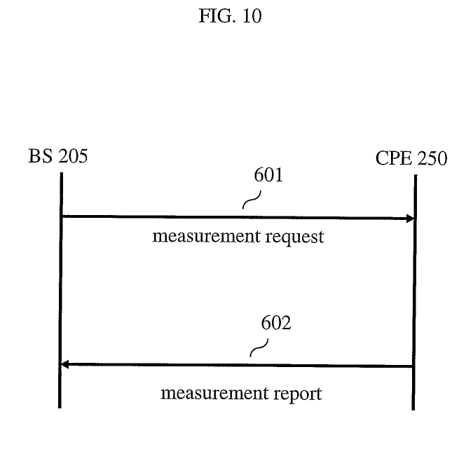

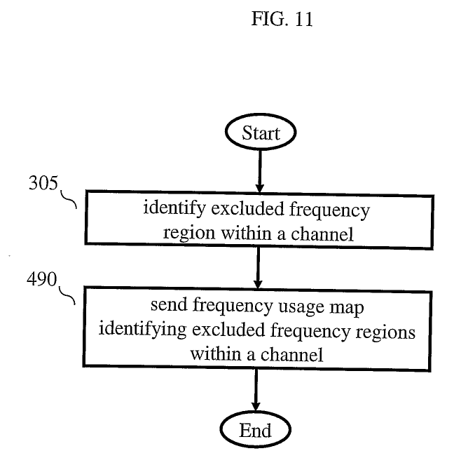

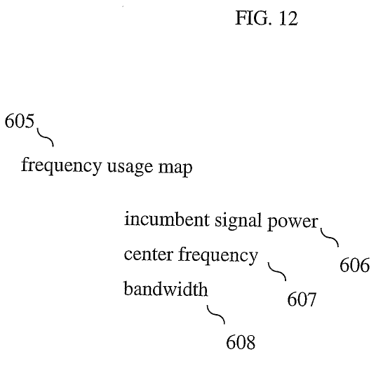

In fact, a wireless endpoint can be instructed to perform channel sensing by another wireless endpoint, where the channel sensing includes the identification of incumbent narrowband signals. This is illustrated in the message flow diagram of FIG. 10 and the flow chart of FIG. 11. BS 205 sends a measurement request 601 to CPE 250 via the earlier-described DL subframe 101. The measurement request may be sent during idle or normal operations and may pertain to one, or more, channels. Upon receipt of the measurement request, CPE 250, in step 305 of FIG. 11, identifies excluded frequency regions and forms a frequency usage map by, e.g., performing the flow chart of FIG. 7 for each of the TV channels shown in Table One of FIG. 1. Once the frequency usage map is determined, CPE 250 sends, in step 490 of FIG. 11, the resulting measurement report 602, including the frequency usage map that includes any identified incumbent narrowband signals, to BS 205 via the earlier-described UL subframe 102. It should also be noted that the CPE may autonomously send measurement reports to the base station. As such, a base station may enable or disable measurement requests or autonomous measurement reports from a CPE by transmitting, e.g., predefined information elements in a DL subframe that are associated with a measurement request. These predefined information elements include, e.g., an “enable bit” set to 1, along with a “request bit” and a “report bit” set to 0 or 1, as appropriate. Illustratively, all measurement requests and reports are enabled by default. A measurement report message comprises information elements such as incumbent signal power, center frequency and bandwidth. In addition, a measurement report message may also contain information such as histogram of the incumbent signal power. Some illustrative information elements for use in a frequency usage map are shown in FIG. 12. Frequency usage map 605 comprises three information elements (IE): incumbent signal power IE 606, center frequency IE 607 and bandwidth IE 608. Thus, the bandwidth, center frequency and power of an incumbent narrowband signal can be identified and sent to another wireless endpoint, which can use this information to identify one, or more, subcarriers (or subchannels) for exclusion such that OFDM transmission in that channel does not interfere with the incumbent narrowband signal. It should be noted that other forms of a frequency usage map, or message, can be used in accordance with the principles of the invention. For example, a frequency usage map may list only those frequencies or subcarriers or subchannels that are available for use in forming an OFDM signal for a channel. Conversely, a frequency usage map may list only those frequencies or subcarriers or subchannels that are not available for use in forming an OFDM signal for a channel, etc.

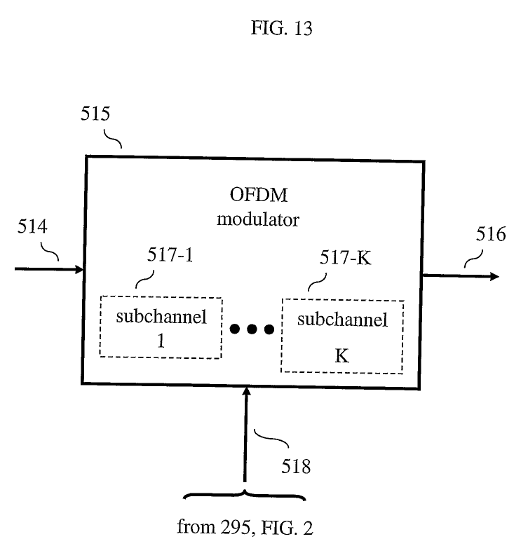

An illustrative embodiment of an OFDM modulator 515 for use in transceiver 285 is shown in FIG. 13. OFDM modulation is performed by using K subcarrier subsets, or subchannels, 117-1 through 117-K, where K>1. In the example described above, K=16 as shown in FIG. 4. In accordance with the principles of the invention, OFDM modulator 515 receives signal 514, which is representative of a data-bearing signal, and modulates this data-bearing signal, for broadcast on a selected channel in accordance with frequency usage map information provided via signal 518, e.g., from processor 295 of FIG. 2. As described above, OFDM modulator 515 forms the resulting OFDM signal 516 for transmission by excluding from transmission those subcarriers that are indicated as interfering with a detected incumbent narrowband signal.

As described above, the performance of a WRAN system is enhanced by using a dynamic frequency selection mechanism such that a wireless endpoint can still use a selected channel even in the presence of an incumbent narrowband signal. It should be noted that although some of the figures, e.g., the receiver of FIG. 8, were described in the context of CPE 250 of FIG. 2, the invention is not so limited and also applies to, e.g., BS 205 that may perform channel sensing in accordance with the principles of the invention.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of the steps shown in, e.g., FIGS. 6 and 7, etc. Further, the principles of the invention are not limited to a WRAN system and are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention as defined by the appended claims.

1. A method for use in a wireless endpoint, the method comprising:
identifying at least one excluded frequency region within a channel;
transmitting an orthogonal frequency division multiplexed (OFDM) based signal in he channel, the OFDM based signal including a number of subcarriers; and
wherein the transmitting step includes the step of
excluding from transmission those subcarriers that fall within the at least one excluded frequency region.

2. The method of claim 1, wherein the identifying step includes:
detecting an interfering signal; and
identifying the at least one excluded frequency region from the detected interfering signal.

3. The method of claim 2, wherein the at least one excluded frequency region corresponds to at least a portion of a frequency spectrum of the detected interfering signal.

4. The method of claim 1, wherein the number of subcarriers is divided among a number of subchannels and wherein the excluding from transmission step excludes at least one subchannel.

5. The method of claim 1, wherein the identifying step includes:
receiving a message from another wireless endpoint; and
identifying the at least one excluded frequency region from information in the received message.

6. The method of claim 5, wherein the received message comprises a frequency usage map.

7. The method of claim 6, wherein the frequency usage map identifies frequency regions that are to be excluded from use in a channel by the wireless endpoint.

8. The method of claim 6, wherein the frequency usage map identifies frequency regions that are available for use by the wireless endpoint.

9. The method of claim 1, wherein the wireless endpoint is a part of a Wireless Regional Area Network (WRAN).

10. Apparatus for use in a wireless endpoint, the apparatus comprising:
a modulator for transmitting an orthogonal frequency division multiplexed (OFDM) based signal in a channel, the OFDM based signal including a number of subcarriers; and
a processor for controlling the modulator to exclude from transmission those subcarriers that fall within at least one excluded frequency region.

11. The apparatus of claim 10, further comprising:
a tuner for tuning to a channel; and
a signal detector for detecting an interfering signal present in the channel, the detected interfering signal being associated with the at least one excluded frequency region.

12. The apparatus of claim 11, wherein the at least one excluded frequency region corresponds to at least a portion of a frequency spectrum of the detected interfering signal.

13. The apparatus of claim 10, wherein the number of subcarriers is divided among a number of subchannels and wherein the processor controls the modulator to exclude from transmission at least one subchannel.

14. The apparatus of claim 10, wherein the processor is responsive to a message received from another wireless endpoint; and wherein the received message identifies the at least one excluded frequency region.

15. The apparatus of claim 14, wherein the received message comprises a frequency usage map.

16. The apparatus of claim 15, wherein the frequency usage map identifies frequency regions that are to be excluded from use in a channel by the wireless endpoint.

17. The apparatus of claim 15, wherein the frequency usage map identifies frequency regions that are available for use by the wireless endpoint.

18. The apparatus of claim 10, wherein the wireless endpoint is a part of a Wireless Regional Area Network (WRAN).
